(19) United States
(12) Patent Application Publication
(10) Pub. No.: US 2026/0105478 A1
(43) Pub. Date: Apr. 16, 2026

(54) DEMAND PREDICTION DISPLAY DEVICE, DEMAND PREDICTION DISPLAY METHOD, AND MEDIUM

(71) Applicant: NEC Corporation, Tokyo (JP)

(72) Inventor: Yudai YAMAGUCHI, Tokyo (JP)

(73) Assignee: NEC Corporation, Tokyo (JP)

(21) Appl. No.: 19/347,922

(22) Filed: Oct. 2, 2025

(30) Foreign Application Priority Data
Oct. 15, 2024 (JP) 2024-179926

(51) Int. Cl. G06Q 30/0202; G06Q 10/087

(52) U.S. Cl. CPC G06Q 30/02022; G06Q 10/0877

(57) ABSTRACT

A demand prediction display device includes: a memory configured to store instructions; and one or more processors configured to execute the instructions to: predict a demand of a consumer of a product in a prediction target period by using purchase record data of the product by the consumer; predict a demand for a wholesale shipment of the product in the prediction target period by using wholesale shipment record data of the product by a wholesaler; predict a demand for a manufacturer shipment in the prediction target period by using manufacturer shipment record data of the product by a manufacturer; and display a prediction result of the demand of the consumer, a prediction result of the demand for the wholesale shipment, and a prediction result of the demand for the manufacturer shipment on a display device on a common time axis.

This application is based upon and claims the benefit of priority from Japanese Patent Application No. 2024-179926, filed on October 15, 2024, the disclosure of which is incorporated herein in its entirety by reference.

### TECHNICAL FIELD

The present disclosure relates to a technology for displaying a demand prediction.

### BACKGROUND ART

A technology for performing demand prediction is known. For example, JP 2022-084757 A discloses a prediction system that acquires, as input information, a category of a product, number of products shipped from a wholesaler to a retailer one day to seven days before a target date, and number of inventory days or average number of products sold at the retailer, and inputs the input information to a learning model generated by executing supervised learning, thereby outputting, from the learning model, prediction information regarding the number of products shipped by the wholesaler to the retailer on the target date.

### SUMMARY

The present disclosure has been made in view of the above problems, and an example object of the present disclosure is to provide a technology for more accurately performing demand prediction of a product.

A demand prediction display device according to an example aspect of the present disclosure includes a consumption prediction means for predicting a demand of a consumer for each unit period of a product in a prediction target period by using purchase record data indicating a purchase record of the product by the consumer, a wholesale shipment prediction means for predicting a demand for a wholesale shipment for the each unit period of the product in the prediction target period by using wholesale shipment record data indicating a shipment record of the product by a wholesaler, a manufacturer shipment prediction means for predicting a demand for a manufacturer shipment for the each unit period in the prediction target period by using manufacturer shipment record data indicating a shipment record of the product by a manufacturer, and a display control means for displaying a prediction result of the demand of the consumer, a prediction result of the demand for the wholesale shipment, and a prediction result of the demand for the manufacturer shipment for the each unit period in the prediction target period on a display device on a common time axis.

A demand prediction display method according to an example aspect of the present disclosure includes consumption prediction processing in which at least one processor predicts a demand of a consumer for each unit period of a product in a prediction target period by using purchase record data indicating a purchase record of the product by the consumer, wholesale shipment prediction processing in which the at least one processor predicts a demand for a wholesale shipment for the each unit period of the product in the prediction target period by using wholesale shipment record data indicating a shipment record of the product by a wholesaler, manufacturer shipment prediction processing in which the at least one processor predicts a demand for a manufacturer shipment for the each unit period in the prediction target period by using manufacturer shipment record data indicating a shipment record of the product by a manufacturer, and display control processing in which the at least one processor displays a prediction result of the demand of the consumer, a prediction result of the demand for the wholesale shipment, and a prediction result of the demand for the manufacturer shipment for the each unit period in the prediction target period on a display device on a common time axis.

A demand prediction display program according to an example aspect of the present disclosure is a program for causing a computer to function as a demand prediction display device, the demand prediction display program causing the computer to function as a consumption prediction means for predicting a demand of a consumer for each unit period of a product in a prediction target period by using purchase record data indicating a purchase record of the product by the consumer, a wholesale shipment prediction means for predicting a demand for a wholesale shipment for the each unit period of the product in the prediction target period by using wholesale shipment record data indicating a shipment record of the product by a wholesaler, a manufacturer shipment prediction means for predicting a demand for a manufacturer shipment for the each unit period in the prediction target period by using manufacturer shipment record data indicating a shipment record of the product by a manufacturer, and a display control means for displaying a prediction result of the demand of the consumer, a prediction result of the demand for the wholesale shipment, and a prediction result of the demand for the manufacturer shipment for the each unit period in the prediction target period on a display device on a common time axis.

### BRIEF DESCRIPTION OF THE DRAWINGS

FIG. 1 is a block diagram illustrating a configuration of a demand prediction display device according to the present disclosure;

FIG. 2 is a flowchart illustrating a flow of a demand prediction display method according to the present disclosure;

FIG. 3 is a diagram illustrating a configuration of a demand prediction system according to the present disclosure;

FIG. 4 is a block diagram illustrating a configuration of an information processing device according to the present disclosure;

FIG. 5 is a diagram illustrating an example of a demand prediction screen according to the present disclosure;

FIG. 6 is a diagram illustrating an example of another demand prediction screen according to the present disclosure; and

FIG. 7 is a block diagram illustrating a configuration of a computer that functions as the demand prediction display device and the information processing device according to the present disclosure.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining technologies (some or all of things or methods) adopted in the following example embodiments can also be included in the scope of the present disclosure. Example embodiments obtained by appropriately omitting some of the technologies adopted in the following example embodiments can also be included in the scope of the present disclosure. Effects mentioned in the following example embodiments are examples of effects expected in the example embodiments, and do not define extension of the present disclosure. In other words, example embodiments that do not provide the effects mentioned in the following example embodiments can also be included in the scope of the present disclosure.

### [First Example Embodiment]

A first example embodiment that is an example of the example embodiments of the present disclosure will be described in detail with reference to the drawings. The present example embodiment is a basic form of each example embodiment to be described below. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in the drawings referred to for describing the present example embodiment can also be adopted in another example embodiment included in the present disclosure within a range in which no particular technical problem occurs.

### (Configuration of Demand Prediction Display Device)

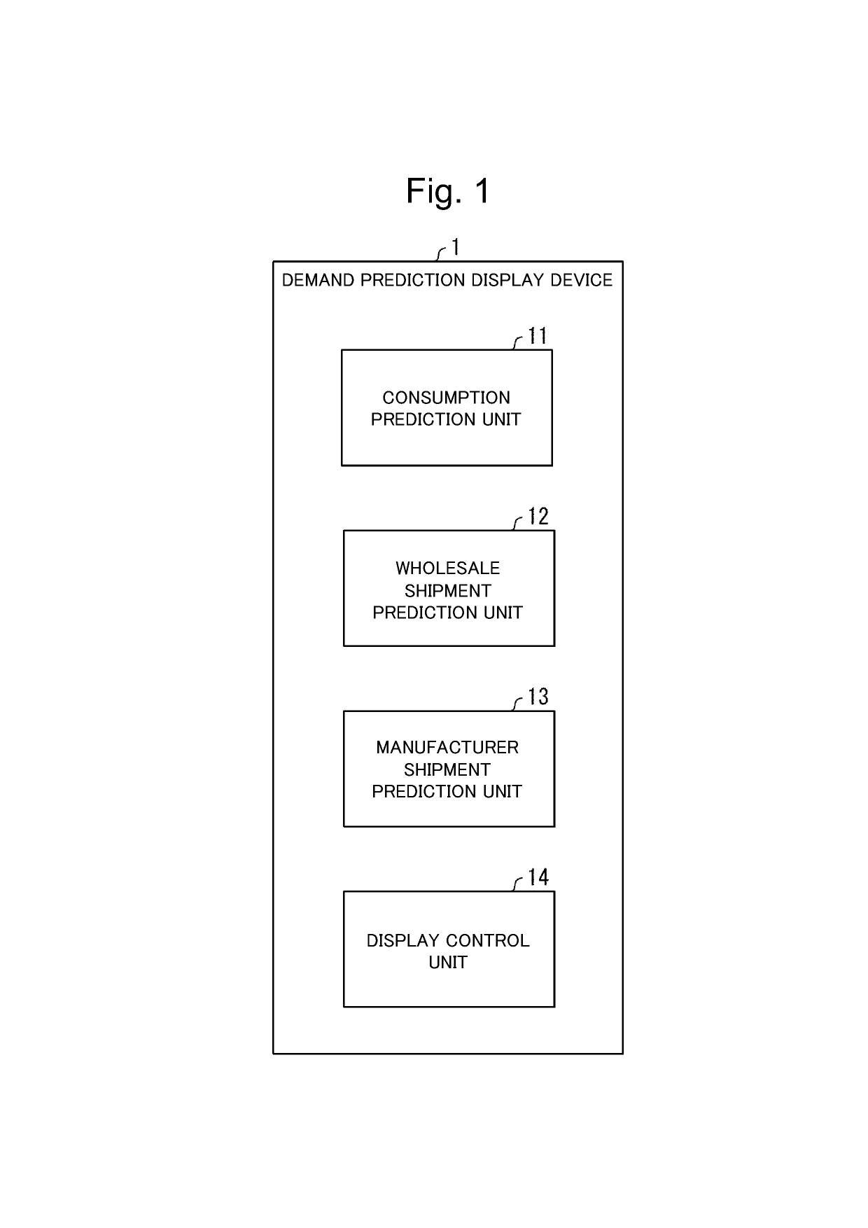

A configuration of a demand prediction display device 1 will be described with reference to FIG. 1. FIG. 1 is a block diagram illustrating a configuration of the demand prediction display device 1. As illustrated in FIG. 1, the demand prediction display device 1 includes a consumption prediction unit 11, a wholesale shipment prediction unit 12, a manufacturer shipment prediction unit 13, and a display control unit 14.

The consumption prediction unit 11 predicts a demand of a consumer for each unit period of a product in a prediction target period by using purchase record data indicating a purchase record of the product by the consumer. The wholesale shipment prediction unit 12 predicts a demand for a wholesale shipment for each unit period of the product in the prediction target period by using wholesale shipment record data indicating a shipment record of the product by the wholesaler. The manufacturer shipment prediction unit 13 predicts a demand for a manufacturer shipment for each unit period in the prediction target period by using manufacturer shipment record data indicating a shipment record of the product by the manufacturer. The display control unit 14 displays a prediction result of the demand of the consumer, a prediction result of the demand for the wholesale shipment, and a prediction result of the demand for the manufacturer shipment for each unit period in the prediction target period on a display device on a common time axis.

### (Effects of Demand Prediction Display Device)

As described above, the demand prediction display device 1 adopts a configuration including the consumption prediction unit 11 for predicting a demand of a consumer for each unit period of a product in the prediction target period by using purchase record data indicating a purchase record of the product by the consumer, the wholesale shipment prediction unit 12 for predicting a demand for a wholesale shipment for each unit period of the product in the prediction target period by using wholesale shipment record data indicating a shipment record of the product by the wholesaler, the manufacturer shipment prediction unit 13 for predicting a demand for a manufacturer shipment for each unit period in the prediction target period by using manufacturer shipment record data indicating a shipment record of the product by the manufacturer, and the display control unit 14 for displaying a prediction result of the demand of the consumer, a prediction result of the demand for the wholesale shipment, and a prediction result of the demand for the manufacturer shipment for each unit period in the prediction target period on the display device on a common time axis. Therefore, according to the demand prediction display device 1, an effect that information for more accurately performing demand prediction of a product can be presented to a user is obtained.

### (Flow of Demand Prediction Display Method)

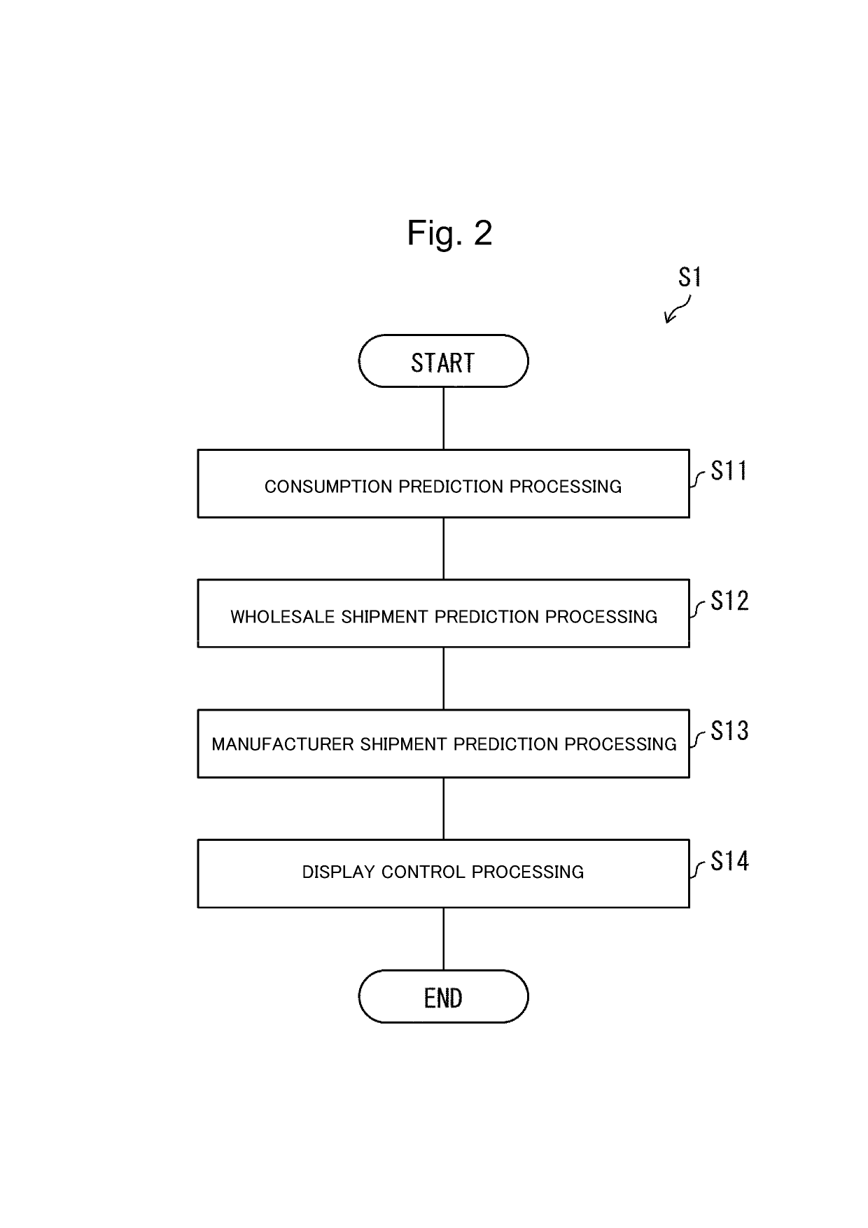

A flow of a demand prediction display method S1 will be described with reference to FIG. 2. FIG. 2 is a flowchart illustrating a flow of the demand prediction display method S1. As illustrated in FIG. 2, the demand prediction display method S1 includes consumption prediction processing S11, wholesale shipment prediction processing S12, manufacturer shipment prediction processing S13, and display control processing S14.

In the consumption prediction processing S11, at least one processor predicts a demand of a consumer for each unit period of a product in a prediction target period by using the purchase record data indicating a purchase record of the product by the consumer. In the wholesale shipment prediction processing S12, the at least one processor predicts a demand for the wholesale shipment for each unit period of the product in the prediction target period by using the wholesale shipment record data indicating a shipment record of the product by the wholesaler. In the manufacturer shipment prediction processing S13, the at least one processor predicts a demand for the manufacturer shipment for each unit period in the prediction target period by using the manufacturer shipment record data indicating a shipment record of the product by the manufacturer. In the display control processing S14, the at least one processor displays a prediction result of the demand of the consumer, a prediction result of the demand for the wholesale shipment, and a prediction result of the demand for the manufacturer shipment for each unit period in the prediction target period on the display device on a common time axis.

### (Effect of Demand Prediction Display Method)

As described above, the demand prediction display method S1 adopts a configuration including the consumption prediction processing S11 in which at least one processor predicts a demand of a consumer for each unit period of a product in a prediction target period by using the purchase record data indicating a purchase record of the product by the consumer, the wholesale shipment prediction processing S12 in which the at least one processor predicts a demand for the wholesale shipment for each unit period of the product in the prediction target period by using the wholesale shipment record data indicating a shipment record of the product by the wholesaler, the manufacturer shipment prediction processing S13 in which the at least one processor predicts a demand for the manufacturer shipment for each unit period in the prediction target period by using the manufacturer shipment record data indicating a shipment record of the product by the manufacturer, and the display control processing S14 in which the at least one processor displays a prediction result of the demand of the consumer, a prediction result of the demand for the wholesale shipment, and a prediction result of the demand for the manufacturer shipment for each unit period in the prediction target period on the display device on a common time axis. Therefore, according to the demand prediction display method S1, an effect that information for more accurately performing demand prediction of a product can be presented to a user is obtained.

### [Second Exemplary Example Embodiment]

A second example embodiment that is an example of the example embodiments of the present disclosure will be described in detail with reference to the drawings. Components that have the same functions as the components described in the above-described example embodiment are denoted by the same reference signs, and description of the components will be appropriately omitted. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in each of the drawings referred to for describing the present example embodiment can be employed in the other example embodiments included in the present disclosure within a range in which no particular technical problem occurs.

### [Configuration of Demand Prediction System]

A demand prediction system 100A according to the present disclosure is a system that predicts a demand for a product. In distribution of products, it is common that products manufactured by a manufacturer (manufacturer) are shipped to a wholesaler, the wholesaler ships the products to a retailer, and the products are sold to consumers by the retailer. In addition, a consumer may purchase a product directly from a manufacturer via a website such as an electronic commerce (EC; E-commerce) site. The demand prediction system 100A according to the present disclosure does not perform demand prediction only from a shipment record of a manufacturer, but performs diversified demand prediction using a shipment record of a wholesaler, a sales record of a retailer, and the like. More specifically, the demand prediction system 100A performs not only demand prediction of manufacturer shipment but also performs demand prediction of final consumption and demand prediction of wholesale shipment, and presents the prediction result to a user (e.g., a planner of a manufacturer). In addition, the demand prediction system 100A displays a demand prediction result in multiple stages (manufacturer shipment, wholesale shipment, final consumption, etc.) in distribution of products on one screen, and visualizes a market inventory or a market inventory change, which is a difference, thereby achieving more accurate demand prediction.

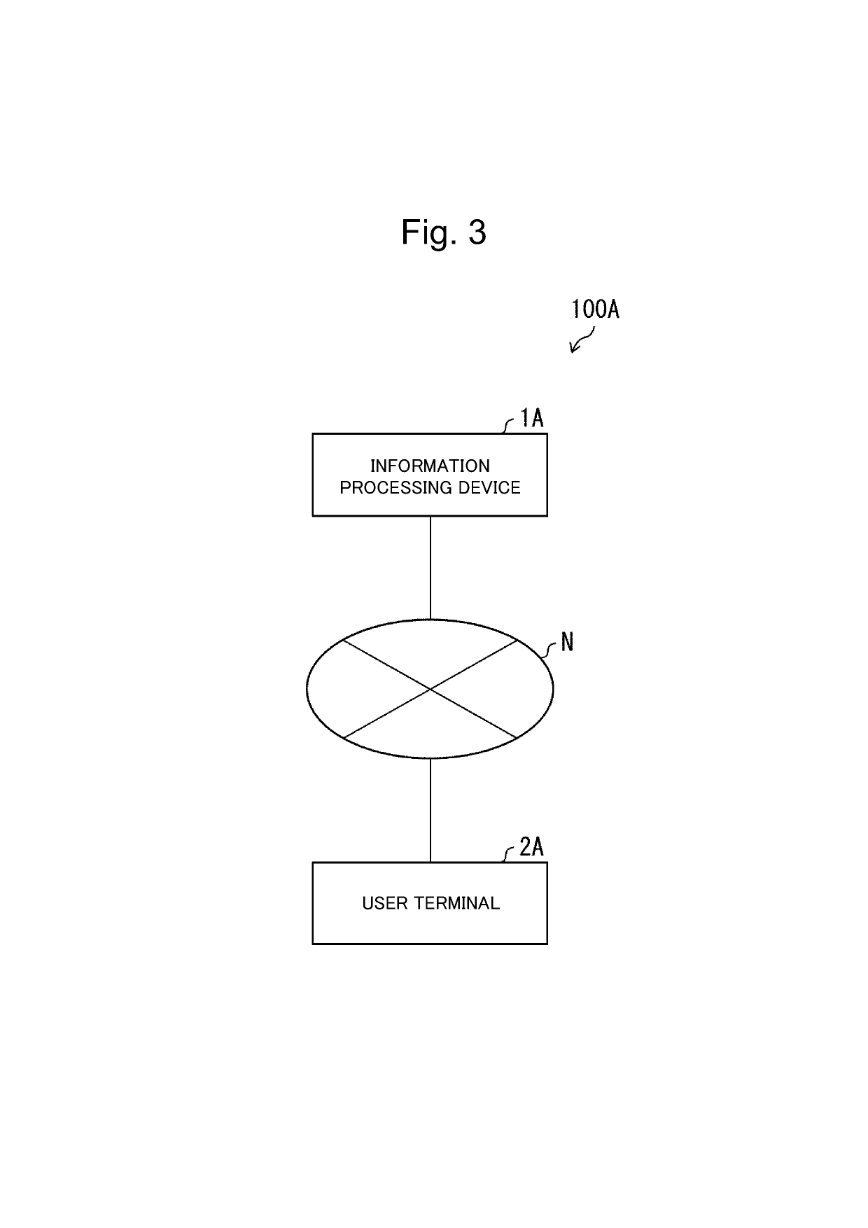

A configuration of the demand prediction system 100A will be described with reference to FIG. 3. FIG. 3 is a diagram illustrating a configuration of the demand prediction system 100A. The demand prediction system 100A includes an information processing device 1A and a user terminal 2A. The information processing device 1A and the user terminal 2A are communicably connected via a communication line N. Although a specific configuration of the communication line N is not limited to the present example embodiment, the communication line N is, by way of example, a wireless Local Area Network (LAN), a wired LAN, a Wide Area Network (WAN), a public line network, a mobile data communication network, or a combination thereof.

The information processing device 1A is a device having a function of predicting a demand for a product, and is, for example, a general-purpose server. The information processing device 1A may also be a personal computer such as a laptop personal computer or a tablet terminal. The user terminal 2A is a terminal used by a user (e.g., a planner of a manufacturer), and is, for example, a personal computer such as a laptop personal computer or a tablet terminal. Although one user terminal 2A is illustrated in the example of FIG. 3, two or more user terminals 2A may be included in the demand prediction system 100A.

### (Configuration of Information Processing Device)

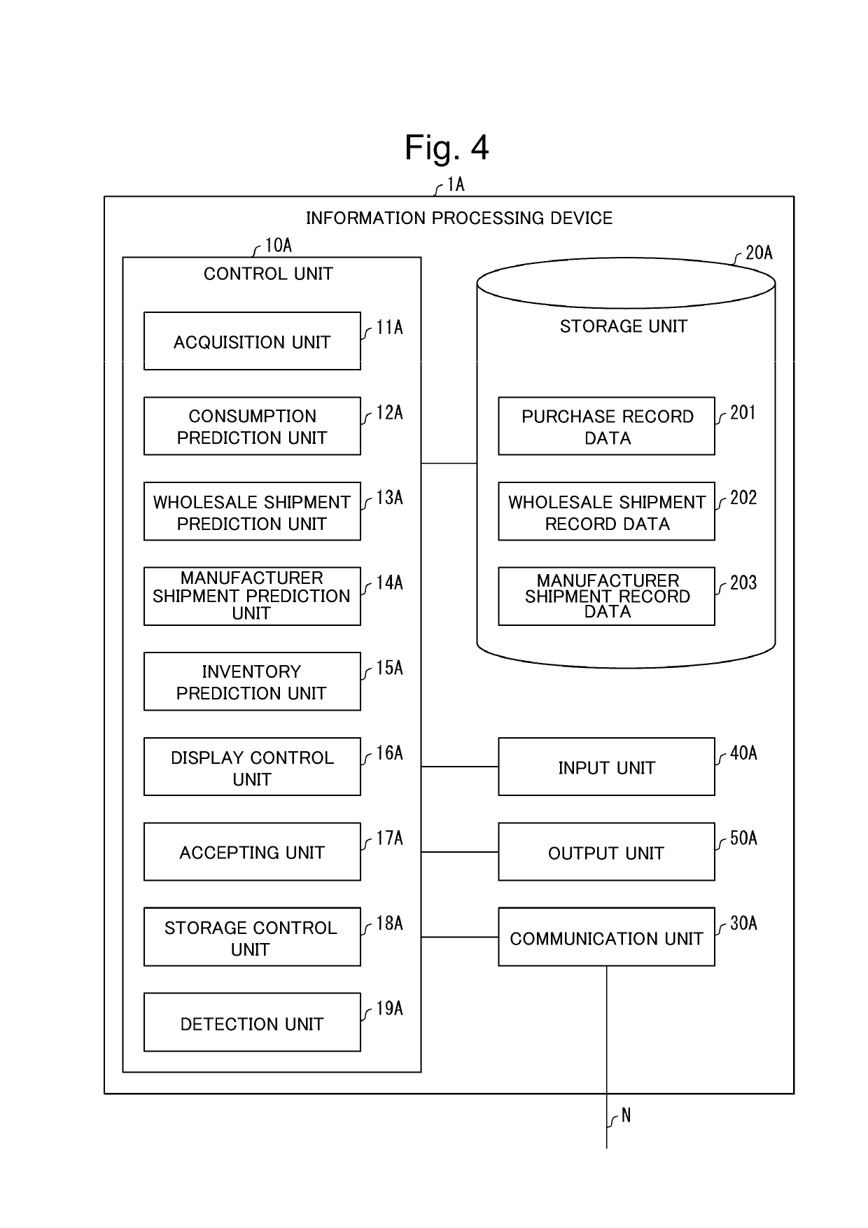

A configuration of the information processing device 1A will be described with reference to FIG. 4. FIG. 4 is a block diagram illustrating a configuration of the information processing device 1A. The information processing device 1A includes a control unit 10A, a storage unit 20A, a communication unit 30A, an input unit 40A, and an output unit 50A. The communication unit 30A communicates with a device (user terminal 2A, etc.) outside the information processing device 1A via the communication line N. The communication unit 30A transmits data supplied from the control unit 10A to another device, and supplies data received from another device to the control unit 10A.

### (Input Unit/Output Unit)

The input unit 40A is a configuration for accepting an input to the information processing device 1A, and includes, as an example, an input device such as a keyboard, a mouse, a touch panel, a camera, or a microphone. The input unit 40A may be configured to accept data from the input device via, for example, an interface such as a Universal Serial Bus (USB). The output unit 50A is a configuration for performing output from the information processing device 1A, and includes, as an example, an output device such as a display, a printer, a touch panel, or a speaker. The output unit 50A may include, for example, an interface such as a USB, and may be configured to output data to the output device via the interface.

### (Storage Unit)

The storage unit 20A stores various types of information to be referred to by the control unit 10A. Examples of such information include purchase record data 201, wholesale shipment record data 202, and manufacturer shipment record data 203.

The purchase record data 201 is data indicating a purchase record of a product by a consumer. The purchase record data 201 includes, for example, Point of sale system (POS) data and EC shipment data. The POS data is data indicating a sales record of a product in a store. As an example, the POS data includes information of a product name, a price, the number of products, a purchase store, a purchase date and time, and customer information (age group, sex, visit date and time, etc.). The EC shipment data is data indicating sales record of a product by electronic commerce. It can also be said that the purchase record data 201 is time-series data indicating the purchase record of a product for each unit period by the consumer.

The wholesale shipment record data 202 is data indicating the shipment record of a product by the wholesaler. The manufacturer shipment record data 203 is data indicating the shipment record of the product by the manufacturer.

### (Control Unit)

The control unit 10A includes an acquisition unit 11A, a consumption prediction unit 12A, a wholesale shipment prediction unit 13A, a manufacturer shipment prediction unit 14A, an inventory prediction unit 15A, a display control unit 16A, an accepting unit 17A, a storage control unit 18A, and a detection unit 19A. The acquisition unit 11A is an example of an acquisition means and an estimation means according to the present disclosure. Each of the consumption prediction unit 12A, the wholesale shipment prediction unit 13A, the manufacturer shipment prediction unit 14A, the inventory prediction unit 15A, the display control unit 16A, the accepting unit 17A, the storage control unit 18A, and the detection unit 19A is an example of a consumption prediction means, a wholesale shipment prediction means, a manufacturer shipment prediction means, an inventory prediction means, a display control means, an accepting means, a storage control means, and a detection means according to the present disclosure.

### (Acquisition Unit)

The acquisition unit 11A acquires the purchase record data 201, the wholesale shipment record data 202, and the manufacturer shipment record data 203. As an example, the acquisition unit 11A may receive the above data from another device via the communication unit 30A. In addition, the acquisition unit 11A may acquire the data input to the input unit 40A. Furthermore, the acquisition unit 11A may acquire the data by reading the data from a storage destination (may be a storage device in the information processing device 1A or may be a storage device outside the information processing device 1A) designated by the user of the information processing device 1A. Hereinafter, in a case where it is not necessary to distinguish each of the purchase record data 201, the wholesale shipment record data 202, and the manufacturer shipment record data 203, these are also referred to as “record data”.

### (Consumption Prediction Unit)

The consumption prediction unit 12A predicts a demand of the consumer for each unit period of the product in the prediction target period by using the purchase record data 201, and generates data indicating the prediction result. Here, the prediction target period is a period targeted for demand prediction, and is, for example, one year, but is not limited thereto. The unit period is a period serving as a unit of demand prediction, and is, for example, one month, one day, or ten-day period, but is not limited thereto. As an example, the data indicating the prediction result is time-series data of prediction values of the demand for each unit period. As an example, the prediction value of the demand is a prediction value of the number of products sold or a prediction value of the sales amount of the product, but is not limited thereto.

The consumption prediction unit 12A predicts a demand of the consumer by, for example, (a) a method by time-series analysis, (b) a method using a trained model, or (c) a method of aggregating information provided by the user. (a) The method by time-series analysis is a method of analyzing data that changes with elapse of time and predicting how data in the next period changes, and a conventional analysis method can be used.

(b) The method using the trained model is a method of performing demand prediction by inputting various data to a trained model generated by machine learning. In this case, examples of the trained model include, but are not limited to, a neural network model such as a convolutional neural network or a recurrent neural network. In this case, the input of the trained model includes, as an example, time-series data (purchase record data) indicating the purchase record of the product for each unit period by the consumer. Furthermore, the input of the trained model may include, in addition to the purchase record data, other data such as information indicating a category of a product, information regarding marketing of a product, and information indicating an external environment of each unit period. The information indicating the category of the product is, for example, information indicating the category of the product such as “drinking water” and “fresh food”. Examples of the information regarding the marketing of the product are, for example, information indicating the scale of the promotion and the period of the promotion. Examples of the information indicating the external environment are, for example, an average temperature and the number of foreign visitors.

Furthermore, as an example, the output of the trained model includes the prediction result of the demand for the product for each unit period in the prediction target period. The trained model is stored in the storage device such as the storage unit 20A. Here, storing the trained model in the storage device means that the parameters defining the trained model are stored in the storage device.

(c) The method of aggregating information provided by the user is a method of aggregating the plan values created by the user (e.g., a manager of a retail store, etc.). In a case where this method is used, as an example, the consumption prediction unit 12A receives a plan value created by a user such as a manager of a retail store via the communication unit 30A, and aggregates the received plan values to predict the demand. However, the method in which the consumption prediction unit 12A predicts the demand is not limited to the above example, and the consumption prediction unit 12A may predict a demand of the consumer by another method.

### (Wholesale Shipment Prediction Unit)

The wholesale shipment prediction unit 13A predicts a demand for the wholesale shipment of a product for each unit period in the prediction target period by using the wholesale shipment record data 202, and generates data indicating the prediction result. As an example, the data indicating the prediction result is time-series data of prediction values of the demand for each unit period. The prediction value of the demand is, as an example, a prediction value of the number of shipments of the product or a prediction value of the sales amount corresponding to the number of shipments of the product, but is not limited thereto.

The wholesale shipment prediction unit 13A predicts a demand for the wholesale shipment by, for example, the above-described (a) a method by time-series analysis, (b) a method using a trained model, or (c) a method of aggregating information presented by the user. However, the method by which the wholesale shipment prediction unit 13A predicts the demand is not limited to the above-described example, and the wholesale shipment prediction unit 13A may predict the demand for the wholesale shipment by another method. The contents of the demand prediction processing performed by the wholesale shipment prediction unit 13A are similar to the contents of the demand prediction processing performed by the consumption prediction unit 12A, but are different in that the wholesale shipment record data 202 is used instead of the purchase record data 201.

### (Manufacturer Shipment Prediction Unit)

The manufacturer shipment prediction unit 14A predicts demand for the manufacturer shipment of the product for each unit period in the prediction target period by using the manufacturer shipment record data 203, and generates data indicating the prediction result. As an example, the data indicating the prediction result is time-series data of prediction values of the demand for each unit period. The prediction value of the demand is, as an example, a prediction value of the number of shipments of the product or a prediction value of the sales amount corresponding to the number of shipments of the product, but is not limited thereto.

The manufacturer shipment prediction unit 14A predicts a demand for the manufacturer shipment by, for example, the above-described (a) a method by time-series analysis, (b) a method using a trained model, or (c) a method of aggregating information presented by the user. However, the method by which the manufacturer shipment prediction unit 14A predicts the demand is not limited to the above-described example, and the manufacturer shipment prediction unit 14A may predict the demand for the manufacturer shipment by another method. The demand prediction processing performed by the manufacturer shipment prediction unit 14A is similar to the demand prediction processing performed by the consumption prediction unit 12A, but is different in that the manufacturer shipment record data 203 is used instead of the purchase record data 201.

### (Inventory Prediction Unit)

The inventory prediction unit 15A predicts the retail inventory amount or change of the product for each unit period in the prediction target period by using a prediction result of the demand of the consumer and a prediction result of the demand for the wholesale shipment. As an example, the inventory prediction unit 15A predicts the retail inventory change of the product for each unit period by using the prediction value of the wholesale shipment for each unit period and the prediction value of the demand of the consumer for each unit period. Furthermore, as an example, the inventory prediction unit 15A may calculate the prediction value of the retail inventory of the product for each unit period by using the prediction value of the wholesale shipment in the unit period, the prediction value of the demand of the consumer in the unit period, and the retail inventory amount in the unit period (e.g., previous month) one before.

Furthermore, the inventory prediction unit 15A predicts the wholesale inventory amount or change of the product for each unit period in the prediction target period by using the prediction result of the demand for the wholesale shipment and the prediction result of the manufacturer shipment. As an example, the inventory prediction unit 15A predicts the wholesale inventory change of the product for each unit period by using the prediction value of the demand for the manufacturer shipment for each unit period and the prediction value of the demand for the wholesale shipment for each unit period. In addition, as an example, the inventory prediction unit 15A may calculate a prediction value of a wholesale inventory of the product for each unit period by using a prediction value of the manufacturer shipment in the unit period, a prediction value of the demand for the wholesale shipment in the unit period, and a manufacturer inventory amount in a unit period (e.g., the previous month) one before.

Furthermore, in addition to the prediction value, the inventory prediction unit 15A may calculate the previous year ratio for the retail inventory amount or change as the prediction result. In addition, the inventory prediction unit 15A may calculate the retail inventory amount or change per one store as the prediction result. In addition, the inventory prediction unit 15A may calculate the previous year ratio for the wholesale inventory amount or change as the prediction result, or may calculate the average value of the number of inventory days of the wholesale inventory as the prediction result.

### (Display Control Unit)

The display control unit 16A outputs data representing various screens to a display (display device), and causes the display to display the screens. The display is, as an example, a display of the user terminal 2A. In this case, the display control unit 16A transmits data representing the screen to the user terminal 2A via the communication unit 30A, and causes the display of the user terminal 2A to display the screen. In the present disclosure, when the display control unit 16A transmits the data representing the screen to the user terminal 2A and causes the display of the user terminal 2A to display the screen, this is also referred to as “the display control unit 16A displays a screen”.

Furthermore, the display control unit 16A may cause the display connected to the output unit 50A to display the screen by outputting the data representing the screen to the display.

The display control unit 16A, in particular, displays the prediction result of the demand of the consumer, the prediction result of the demand for the wholesale shipment, and the prediction result of the demand for the manufacturer shipment for each unit period in the prediction target period on the display device on a common time axis. Hereinafter, the prediction result of the demand of the consumer by the consumption prediction unit 12A, the prediction result of the demand for the wholesale shipment by the wholesale shipment prediction unit 13A, and the prediction result of the demand for the manufacturer shipment by the manufacturer shipment prediction unit 14A are also referred to as “demand prediction result”.

Furthermore, at this time, the display control unit 16A may display the prediction result by the inventory prediction unit 15A on the display on the time axis. In other words, the display control unit 16A may display the prediction value of the inventory of the wholesale shipment predicted by the inventory prediction unit 15A and the prediction value of the inventory of the manufacturer shipment together with the demand prediction result on a common time axis.

In addition, the display control unit 16A may display, on the display on the time axis, at least one of (i) the ratio of the prediction result of the demand of the consumer with respect to the purchase record of the product by the consumer, (ii) the ratio of the prediction result of the demand for the wholesale shipment with respect to the shipment record of the product by the wholesaler, and (iii) the ratio of the prediction result of the demand for the manufacturer shipment with respect to the shipment record of the product by the manufacturer. Furthermore, the display control unit 16A may display a detection result by the detection unit 19A described later on the display.

### (First Screen Example)

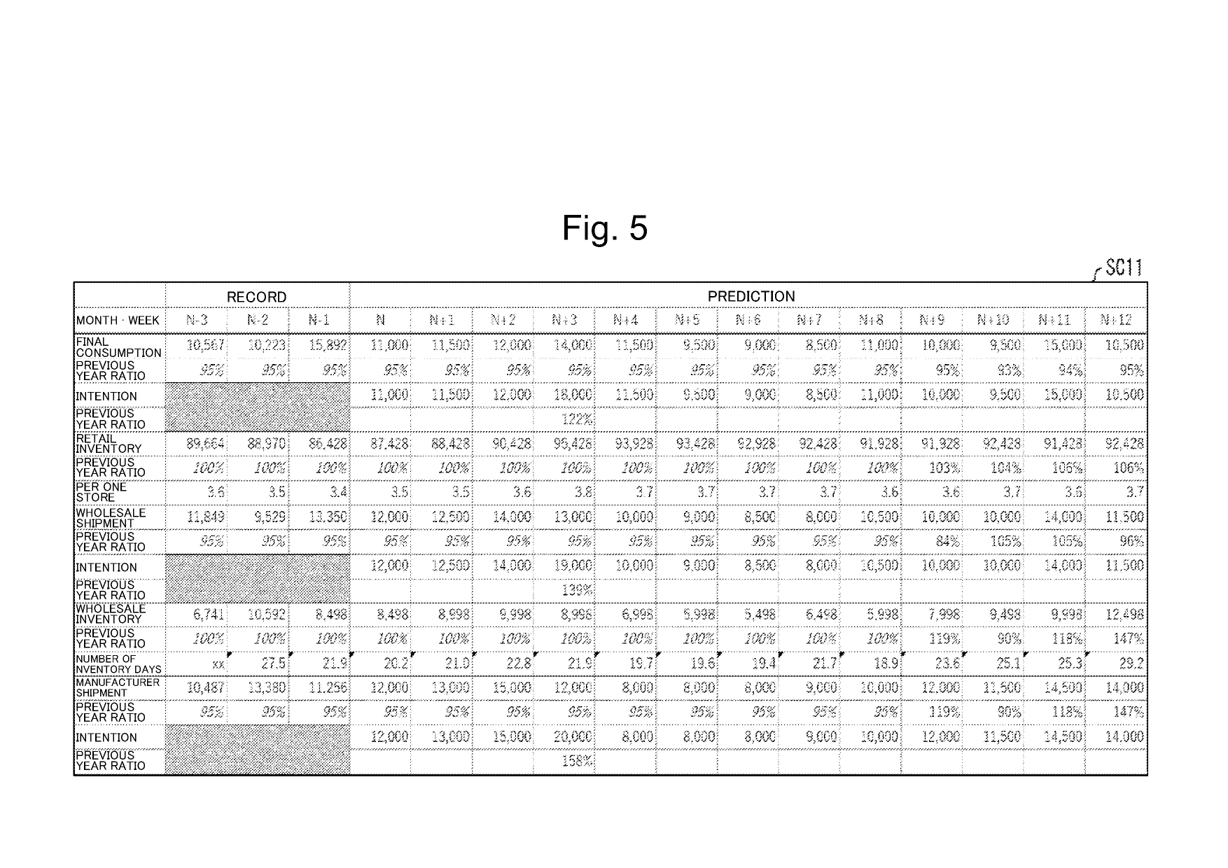

FIG. 5 is a diagram illustrating an example of a demand prediction screen SC11 displayed on the display by the display control unit 16A. In the example of FIG. 5, the demand prediction screen SC11 displays the record data indicating the record of the distribution volume of the products in each of the unit periods N-3, N-2, and N-1, and the prediction result data indicating the prediction result of the demand in each of the unit periods N, N+1, N+2, .... In addition, on the demand prediction screen SC11, the prediction result of the demand of the consumer, the prediction result of the demand for the wholesale shipment, and the prediction result of the manufacturer shipment are displayed on the same time axis.

### (Record Data)

In the example of FIG. 5, the record data is time-series data of the actual values of the distribution volume of the product for each unit period, and includes a plurality of items of “final consumption”, “retail inventory”, “wholesale shipment”, “wholesale inventory”, and “manufacturer shipment”. The “final consumption” is data indicating a sales record (i.e., a purchase record of the product by the consumer) of a product at a retailer. In addition, “final consumption” includes the item “previous year ratio”. “Previous year ratio” is a previous year ratio of the actual value of the sales in each of the unit periods.

The “retail inventory” is data indicating an inventory amount of the retailer. The “retail inventory” includes items “previous year ratio” and “per one store”. “Previous year ratio” is a previous year ratio of the inventory amount of the retailer of the product. “Per one store” is the inventory amount of the product per one store. The “wholesale shipment” is data indicating shipment record of the product by the wholesaler. In addition, “wholesale shipment” includes the item of “previous year ratio”. “Previous year ratio” is a previous year ratio of the shipment record of the product in each of the unit periods.

The “wholesale inventory” is data indicating the inventory amount of the wholesaler. In addition, “wholesale inventory” includes items “previous year ratio” and “number of inventory days”. “Previous year ratio” is a previous year ratio of the inventory amount at the wholesaler of the product in each of the unit periods. The “number of inventory days” is an average value of the number of inventory days at the wholesaler of the product. In the calculation of the “number of inventory days”, for example, the inventory prediction unit 15A may calculate the number of inventory days using the past records with respect to the inventory at that time point, may calculate the number of inventory days using the future demand prediction, or may calculate the number of inventory days by combining them.

“Manufacturer shipment” is data indicating record of a shipment amount of a product by a manufacturer. In addition, “manufacturer shipment” includes the item “previous year ratio”. “Previous year ratio” is a previous year ratio of the shipment record of the product.

### (Prediction Result Data)

The prediction result data is time-series data of the prediction values of the demand for the product for each unit period, and is data generated by the consumption prediction unit 12A, the wholesale shipment prediction unit 13A, and the manufacturer shipment prediction unit 14A. The prediction result data includes a plurality of items of “final consumption”, “retail inventory”, “wholesale shipment”, “wholesale inventory”, and “manufacturer shipment”.

“Final consumption” is data indicating the prediction result of a demand for a product at the retailer, and is data generated by the consumption prediction unit 12A. “Final consumption” includes a plurality of items “previous year ratio”, “intention”, and “previous year ratio”. “Previous year ratio” is the ratio of the prediction result of the demand with respect to the sales record of the product in the previous year in each of the unit periods. In other words, it can also be said that the display control unit 16A displays the ratio of the prediction result of the demand of the consumer with respect to the purchase record of the product by the consumer in each of the unit periods.

“Intention” is an item for the user to change the value of “final consumption”. In the item of “intention”, the same value as the “final consumption” is set as a default value, but the user can change the value of the “intention”. When the user performs an operation of inputting a correction value using an input unit (not illustrated) of the user terminal 2A, the user terminal 2A transmits the correction value input by the user to the information processing device 1A, and the display control unit 16A of the information processing device 1A changes the value of the item of “intention” on the demand prediction screen SC11 to the correction value input by the user. When the value of the item of “intention” is changed, the display control unit 16A sets the ratio of the correction value with respect to the sales record of the product in the previous year to “previous year ratio” at the lower stage of the item of “intention”.

The “retail inventory” is data indicating the prediction result of the inventory amount of the retailer. The “retail inventory” includes items “previous year ratio” and “per one store”. “Previous year ratio” is a previous year ratio of the prediction result of the inventory amount of the retailer of the product. “Per one store” is the inventory amount of the product per one store.

The “wholesale shipment” is an item for displaying the prediction result of the demand for the product in the wholesaler. In addition, “wholesale shipment” includes items of “previous year ratio”, “intention”, and “previous year ratio”. “Previous year ratio” is the ratio of the prediction result of the demand with respect to the shipment record of the product in each of the unit periods. In other words, it can also be said that the display control unit 16A displays the ratio of the prediction result of the demand for the wholesale shipment with respect to the shipment record of the product by the wholesaler.

“Intention” is an item for the user to change the value of “wholesale shipment”. In the item of “intention”, the same value as the “wholesale shipment” is set as a default value, but the user can change the value of the “intention”. When the user performs an operation of inputting a correction value using an input unit (not illustrated) of the user terminal 2A, the user terminal 2A transmits the correction value input by the user to the information processing device 1A, and the display control unit 16A of the information processing device 1A changes the value of the item of “intention” on the demand prediction screen SC11 to the correction value input by the user. When the value of the item of “intention” is changed, the display control unit 16A sets the ratio of the correction value with respect to the shipment record of the product in the previous year to “previous year ratio” at the lower stage of the item of “intention”.

“Wholesale inventory” is an item for displaying the prediction result of the inventory amount of the wholesaler. In addition, “wholesale inventory” includes items “previous year ratio” and “number of inventory days”. “Previous year ratio” is the previous year ratio of the prediction result of the inventory amount of the wholesaler of the product in each of the unit periods. The “number of inventory days” is an average value of the number of inventory days at the wholesaler of the product.

“Manufacturer shipment” is an item for displaying the prediction result of demand for manufacturer shipment. Furthermore, “manufacturer shipment” includes items “previous year ratio”, “intention”, and “previous year ratio”. “Previous year ratio” indicates a ratio of demand for manufacturer shipment with respect to the record of manufacturer shipment in the previous year. In other words, it can also be said that the display control unit 16A displays the ratio of the prediction result of the demand for manufacturer shipment with respect to the shipment record of the product by the manufacturer in each of the unit periods.

“Intention” is an item for the user to change the value of “manufacturer shipment”. In the item of “intention”, the same value as the “manufacturer shipment” is set as a default value, but the user can change the value of the “intention”. When the user performs an operation of inputting a correction value using an input unit (not illustrated) of the user terminal 2A, the user terminal 2A transmits the correction value input by the user to the information processing device 1A, and the display control unit 16A of the information processing device 1A changes the value of the item of “intention” on the demand prediction screen SC11 to the correction value input by the user. When the value of the item of “intention” is changed, the display control unit 16A sets the ratio of the correction value with respect to the shipment record of the product in the previous year to “previous year ratio” at the lower stage of the item of “intention”.

Furthermore, in the screen of FIG. 5, the display control unit 16A may display the record data and the prediction result data on the display in different display modes. In other words, the display control unit 16A may display the prediction result by the consumption prediction unit 12A, the prediction result by the wholesale shipment prediction unit 13A, and the prediction result by the manufacturer shipment prediction unit 14A in a first display mode on the display on the time axis, and display the purchase record indicated by the purchase record data, the shipment record indicated by the wholesale shipment record data, and the shipment record indicated by the manufacturer shipment record data in a second display mode on the display on the time axis. Specifically, as an example, the display control unit 16A may display the demand prediction result and the records on the display in different color schemes.

In addition, in the screen of FIG. 5, the display control unit 16A may display a change value of the inventory amount for each unit period on the display instead of the inventory amount of the retail inventory. At this time, the display control unit 16A may differ the display mode between a case where the change value of the inventory amount is positive (case where the inventory amount has increased) and a case where the change value is negative (case where the inventory amount has decreased). For example, the display control unit 16A may change the display color between a case where the change value of the inventory amount is positive and a case where the change value of the inventory amount is negative.

### (Second Screen Example)

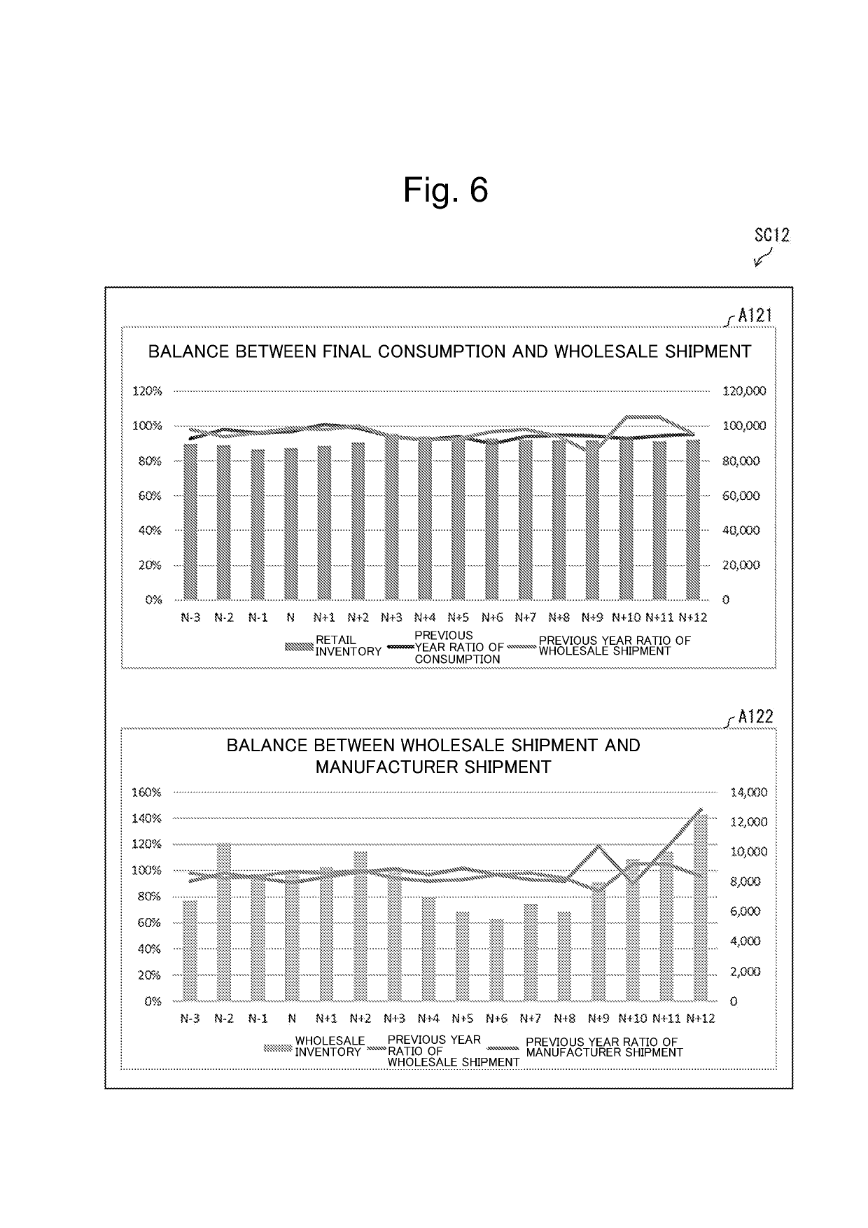

FIG. 6 is a diagram illustrating an example of another demand prediction screen displayed on the display by the display control unit 16A. In the example of FIG. 6, the screen SC12 includes graph display areas A121 and A122. In the graph display area A121, a graph showing a balance between final consumption and wholesale shipment is displayed. In the graph display area A122, a graph showing a balance between wholesale shipment and manufacturer shipment is displayed.

In the graph display area A121, a bar graph showing the transition of the actual and prediction values of the retail inventory, a line graph showing the transition of the previous year ratio of the final consumption, and a line graph showing the previous year ratio of the wholesale shipment are displayed. In addition, in the graph display area A122, a bar graph showing the transition of the actual and prediction values of the wholesale inventory, a line graph showing the previous year ratio of the wholesale shipment, and a line graph showing the previous year ratio of the manufacturer shipment are displayed.

### (Another Example of Screen)

The screen displayed on the display by the display control unit 16A is not limited to the screen illustrated in FIGS. 5 and 6, and the display control unit 16A may display another screen on the display. For example, the display control unit 16A may display the prediction result by the consumption prediction unit 12A, the prediction result by the wholesale shipment prediction unit 13A, and the prediction result by the manufacturer shipment prediction unit 14A on the above display device for each classification related to the sales of the product. Here, examples of the classification related to the sales of the product include, for example, a category type (drinking water, fresh food, etc.) of the product, a type (store sales, directly online sales, for specific large customers, etc.) of a sales channel, a sales region of the product, a customer type, a period (monthly, weekly, daily, etc.), and the like, but are not limited thereto.

In this case, as an example, the display control unit 16A may cause the display to display the demand prediction result for the products of the first classification (e.g., the category is “drinking water”) and the demand prediction result for the products of the second classification (e.g., the category is “fresh food”) on the same time axis.

### (Accepting Unit)

The accepting unit 17A accepts various instructions or selections by the user. As an example, the accepting unit 17A accepts the instruction or the selection by receiving data indicating the instruction or the selection of the user from the user terminal 2A. Furthermore, the accepting unit 17A may accept an instruction or selection input by the user to the input unit 40A.

In particular, the accepting unit 17A accepts an input of a correction value by the user with respect to the prediction result of the demand of the consumer, the prediction result of the demand for the wholesale shipment, and the prediction result of the demand for the manufacturer shipment. In this case, as an example, the display control unit 16A sets the correction value that has been accepted, in the item of “intention” in FIG. 5.

### (Storage Control Unit)

The storage control unit 18A stores all of the prediction result of the demand of the consumer, the prediction result of the demand for the wholesale shipment, the prediction result of the demand for the manufacturer shipment, and the correction value accepted by the accepting unit 17A in the storage unit 20A (storage device). At this time, the storage control unit 18A does not update the demand prediction result with the correction value, but distinguishes and manages the demand prediction result and the correction value.

### (Detection Unit)

The detection unit 19A detects an outlier from the prediction result displayed by the display control unit 16A. In a case where there is a large difference in the trend of demand prediction at each stage, it is possible to estimate that there has been an input mistake by the user or a special movement of inventory securing or inventory decrease in the market. It is possible to support reduction of operation errors by the user and early detection of market trends by detecting such an outlier (a value indicating a movement different from usual) and presenting the outlier to the user.

As an example, the detection unit 19A detects, as an outlier, a prediction value or an actual value satisfying any one of the following conditions (a) to (f) in the prediction value or the actual value for each unit period.

(a) |previous year ratio r1 of consumption prediction - previous year ratio r2 of wholesale shipment prediction| > threshold value th₁₂ (b) |previous year ratio r2 of wholesale shipment prediction - previous year ratio r3 of manufacturer shipment prediction| > threshold value th₂₃ (c) |previous year ratio r1 of consumption prediction - previous year ratio r3 of manufacturer shipment prediction| > threshold value th₁₃ (d) |previous year ratio r4 of consumption record - previous year ratio r5 of wholesale shipment record| > threshold value th₄₅ (e) |previous year ratio r5 of wholesale shipment record - previous year ratio r6 of manufacturer shipment record| > threshold value th₅₆ (f) |previous year ratio r4 of consumption record - previous year ratio r6 of manufacturer shipment record > threshold value th₄₆.

Here, the previous year ratio r1 is a ratio of the consumption prediction of the unit period u with respect to the consumption record of the past unit period (e.g., the same month one year ago) corresponding to the unit period u. The previous year ratio r2 is a ratio of the wholesale shipment prediction of the unit period u with respect to the wholesale shipment record of the past unit period (e.g., the same month one year ago) corresponding to the unit period u. The previous year ratio r3 is a ratio of the manufacturer shipment prediction of the unit period u with respect to the manufacturer shipment record of the past unit period (e.g., the same month one year ago) corresponding to the unit period u.

The previous year ratio r4 is a ratio of the consumption record of the unit period u with respect to the consumption record of the past unit period (e.g., the same month one year ago) corresponding to the unit period u. A previous year ratio r5 is a ratio of the wholesale shipment record of the unit period u with respect to the wholesale shipment record of the past unit period (e.g., the same month one year ago) corresponding to the unit period u. The previous year ratio r6 is a ratio of the manufacturer shipment record of the unit period u with respect to the manufacturer shipment record of the past unit period (e.g., the same month one year ago) corresponding to the unit period u. For example, 0.2 is set for each of the threshold value th₁₂ to the threshold value th₅₆.

Among the conditions (a) to (f) described above, the conditions (a) to (c) are used to check an input error of the correction value by the user or an outlier. On the other hand, (d) to (f) are used to consider a sudden change in market inventory in the subsequent demand prediction.

In a case where the conditions (a) to (c) are used, in other words, it can be said that the detection unit 19A detects an outlier, from the prediction result displayed by the display control unit 16A, based on at least one of (i) a comparison result between a ratio of the prediction result of the demand of the consumer with respect to the purchase record of the product by the consumer (previous year ratio r1) and a ratio of the prediction result of the demand for the wholesale shipment with respect to the shipment record of the product by the wholesaler (previous year ratio r2), (ii) a comparison result between a ratio of the prediction result of the demand for the wholesale shipment with respect to the shipment record of the product by the wholesaler (previous year ratio r2) and a ratio of the prediction result of the demand for the manufacturer shipment with respect to the shipment record of the product by the manufacturer (previous year ratio r3), and (iii) a comparison result between a ratio of the prediction result of the demand of the consumer with respect to the purchase record of the product by the consumer (previous year ratio r1) and a ratio of the prediction result of the demand for the manufacturer shipment with respect to the shipment record of the product by the manufacturer (previous year ratio r3).

The display control unit 16A displays the detection result by the detection unit 19A on the display. As an example, the display control unit 16A displays, in a highlighted manner, an outlier detected by the detection unit 19A on the demand prediction screen SC11 illustrated in FIG. 5. Here, displaying the outlier in a highlighted manner refers to, for example, making a display mode of the outlier (display color, display size, etc.) different from display modes of other prediction values, or displaying a mark (e.g., a rectangular image surrounding an outlier) indicating that the value is an outlier.

### (Processing Example In Case Where Part of record data Cannot be Acquired)

Here, a processing example in a case where the acquisition unit 11A cannot acquire a part of the record data will be described. The acquisition unit 11A may not be able to acquire some of the purchase record data, the wholesale shipment record data, and the manufacturer shipment record data. For example, in a case where data of all retail stores cannot be collected, the acquisition unit 11A can acquire only a part of the necessary purchase record data. When some of the purchase record data, the wholesale shipment record data, and the manufacturer shipment record data cannot be acquired as described above, the acquisition unit 11A may estimate the data that cannot be acquired by using the acquired data. In this case, as an example, the acquisition unit 11A may estimate a part of the record data by performing an enlarged estimation processing using the acquired record data.

In this case, the display control unit 16A may display the data acquired by the acquisition unit 11A and the data estimated by the acquisition unit 11A on the display on the time axis in different display modes. As an example, the display control unit 16A may display the estimated data and other data on the display in different colors.

### (Effects of Information Processing Device)

As described above, the information processing device 1A displays the prediction result of the demand for the final consumption, the prediction result of the demand for the wholesale shipment, and the prediction result of the demand for the manufacturer shipment on the display on the same time axis. The user of the information processing device 1A can confirm the demand prediction in multiple stages (manufacturer shipment stage, wholesale shipment stage, retail sales stage, etc.) on one screen and easily perform comparison and the like, and thus can more accurately perform the demand prediction of the product.

Furthermore, the information processing device 1A has a configuration of including a detection unit 19A for detecting an outlier from the prediction result displayed by the display control unit 16A based on at least one of (i) a comparison result between a ratio of the prediction result of a demand of a consumer with respect to a purchase record of the product by a consumer and a ratio of the prediction result of a demand for a wholesale shipment with respect to a shipment record of the product by a wholesaler, (ii) a comparison result between a ratio of the prediction result of a demand for a wholesale shipment with respect to a shipment record of the product by a wholesaler and a ratio of the prediction result of a demand for a manufacturer shipment with respect to a shipment record of the product by a manufacturer, and (iii) a comparison result between a ratio of the prediction result of a demand of a consumer with respect to a purchase record of the product by a consumer and a ratio of the prediction result of a demand for a manufacturer shipment with respect to a shipment record of a product by a manufacturer, and the display control unit 16A adopts a configuration that displays the detection result by the detection unit 19A on a display.

As described above, in a case where there is a large difference in the trend of demand prediction at each stage, it is possible to estimate that there has been an input mistake by the user, or a special inventory securing or inventory decrease movement in the market. According to the information processing device 1A, it is possible to support reduction of operation errors by the user and early detection of market trends by pointing out the outliers in the past record and the future prediction on the screen. For example, by issuing an alert in a case where the movement is different from usual, the user can notice that at an early timing.

In addition, the information processing device 1A has a configuration of including the inventory prediction unit 15A for predicting the retail inventory amount or change of the product for each unit period in the prediction target period by using the prediction result of the demand of the consumer and the prediction result of the demand for the wholesale shipment, and the display control unit 16A adopts a configuration that displays the prediction result by the inventory prediction unit 15A on the display on the time axis. Therefore, according to the information processing device 1A, the user can perform demand prediction with higher accuracy in view of the market inventory in addition to the demand prediction result. As described above, according to the information processing device 1A according to the present disclosure, visualization in which the balance among the final consumption, the wholesale shipment, and the manufacturer shipment, and the transition of the market inventory can be recognized becomes possible.

In addition, the information processing device 1A has a configuration of including the inventory prediction unit 15A for predicting the wholesale inventory amount or change of the product for each unit period in the prediction target period by using the prediction result of the demand for the wholesale shipment and the prediction result of the manufacturer shipment, and the display control unit 16A adopts a configuration that displays the prediction result by the inventory prediction unit 15A on the display on the time axis. Therefore, according to the information processing device 1A, the user can perform demand prediction with higher accuracy in view of the market inventory in addition to the demand prediction result. As described above, according to the information processing device 1A according to the present disclosure, visualization in which the balance among the final consumption, the wholesale shipment, and the manufacturer shipment, and the transition of the market inventory can be recognized becomes possible.

Furthermore, in the information processing device 1A, a configuration is adopted in which the display control unit 16A adopts a configuration that displays, on the display on the time axis, at least one of (i) a ratio of the prediction result of a demand of a consumer with respect to a purchase record of the product by a consumer, (ii) a ratio of the prediction result of a demand for wholesale shipment with respect to a shipment record of the product by a wholesaler, and (iii) a ratio of the prediction result of a demand for manufacturer shipment with respect to a shipment record of the product by a manufacturer. Therefore, according to the information processing device 1A, in a case where movement is different from usual in the transition of the past record and the transition of the future prediction, the user can grasp a portion where the movement is different from usual in the transition of the past record and the transition of the future prediction by checking the screen displayed on the display.

Furthermore, in the information processing device 1A, the display control unit 16A adopts a configuration that displays the prediction result by the consumption prediction unit 12A, the prediction result by the wholesale shipment prediction unit 13A, and the prediction result by the manufacturer shipment prediction unit 14A on the display for each classification related to the sale of the product. Therefore, according to the information processing device 1A, more detailed demand prediction can be supported.

In addition, the information processing device 1A has a configuration of including an acquisition unit 11A for acquiring the purchase record data, the wholesale shipment record data, and the manufacturer shipment record data, and estimating, in a case where a part of the purchase record data, the wholesale shipment record data, and the manufacturer shipment record data cannot be acquired, data that could not be acquired by using the acquired record data, and the display control unit 16A adopts a configuration that displays the data acquired by the acquisition unit 11A and the estimated data on the display on the time axis in different display modes. The user can more accurately perform the demand prediction by checking the screen on which the collected data and the estimated data are displayed in a distinguished manner.

In addition, the information processing device 1A adopts configurations of including: an accepting unit 17A for accepting an input of a correction value by the user for the prediction result of the demand of the consumer, the prediction result of the demand for the wholesale shipment, and the prediction result of the demand for the manufacturer shipment, and a storage control unit 18A for storing a prediction result of the demand of the consumer, a prediction result of the demand for the wholesale shipment, a prediction result of the demand for the manufacturer shipment, and a correction value accepted by the accepting unit 17A in the storage unit 20A. The demand prediction results by the consumption prediction unit 12A, the wholesale shipment prediction unit 13A, and the manufacturer shipment prediction unit 14A are not updated, but the demand prediction result and the correction value by the user are managed in a distinguished manner, so that the user can perform the demand prediction in consideration of both the demand prediction result and the correction value by the user, whereby the demand prediction can be performed more accurately.

### (Implementation Example by Software)

Some or all of the functions of the demand prediction display device 1 and the information processing device 1A (hereinafter, also referred to as “each of the above devices”) may be achieved by hardware such as an integrated circuit (IC chip) or may be achieved by software.

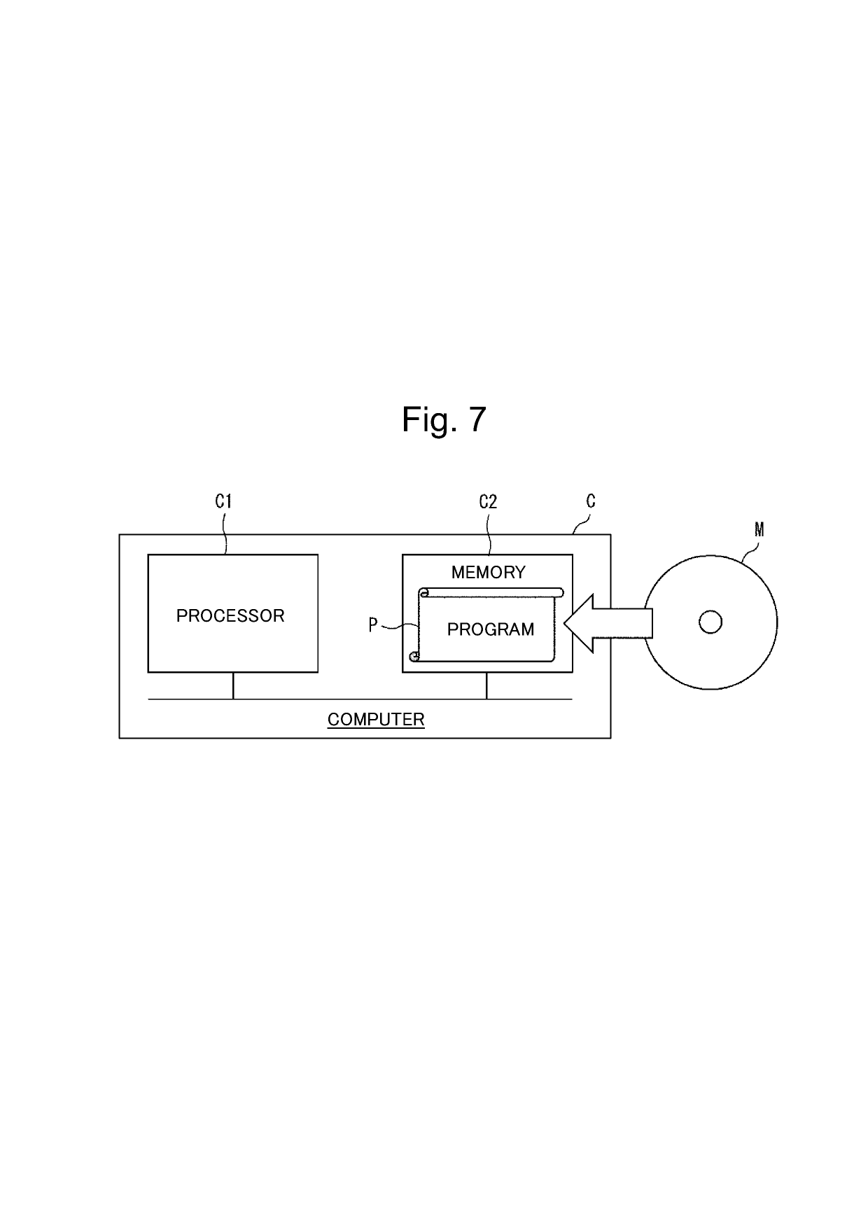

In the latter case, each of the above devices is achieved by, for example, a computer that executes a command of a program as software for achieving each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

According to an exemplary aspect of the present disclosure, there is an exemplary effect that it is possible to provide a technology for more accurately performing demand prediction of a product.

### (Supplementary Matter A)

The present disclosure includes technologies described in the following Supplementary Notes. However, the present disclosure is not limited to the technologies described in the following Supplementary Notes, and various modifications can be made within the scope described in the claims.

### (Supplementary Note A1)

A demand prediction display device including:

a consumption prediction means for predicting a demand of a consumer for each unit period of a product in a prediction target period by using purchase record data indicating a purchase record of the product by the consumer,

a wholesale shipment prediction means for predicting a demand for a wholesale shipment for the each unit period of the product in the prediction target period by using wholesale shipment record data indicating a shipment record of the product by a wholesaler,

a manufacturer shipment prediction means for predicting a demand for a manufacturer shipment for the each unit period in the prediction target period by using manufacturer shipment record data indicating a shipment record of the product by a manufacturer, and

a display control means for displaying a prediction result of the demand of the consumer, a prediction result of the demand for the wholesale shipment, and a prediction result of the demand for the manufacturer shipment for the each unit period in the prediction target period on a display device on a common time axis.

### (Supplementary Note A2)

The demand prediction display device according to Supplementary Note A1, further including:

a detection means for detecting an outlier from the prediction result displayed by the display control means based on at least one of,

(i) a comparison result between a ratio of the prediction result of the demand of the consumer with respect to the purchase record of the product by the consumer and a ratio of the prediction result of the demand for the wholesale shipment with respect to the shipment record of the product by the wholesaler,

(ii) a comparison result between a ratio of the prediction result of the demand for the wholesale shipment with respect to the shipment record of the product by the wholesaler and a ratio of the prediction result of the demand for the manufacturer shipment with respect to the shipment record of the product by the manufacturer, and

(iii) a comparison result between a ratio of the prediction result of the demand of the consumer with respect to a purchase record of the product by the consumer and a ratio of the prediction result of the demand for the manufacturer shipment with respect to the shipment record of the product by the manufacturer, in which

the display control means displays the detection result by the detection means on the display device.

### (Supplementary Note A3)

The demand prediction display device according to Supplementary Note A1 or A2, further including:

an inventory prediction means for predicting a retail inventory amount or change of the product for the each unit period in the prediction target period by using the prediction result of the demand of the consumer and the prediction result of the demand for the wholesale shipment, in which

the display control means displays the prediction result by the inventory prediction means on the display device on the time axis.

### (Supplementary Note A4)

The demand prediction display device according to any one of Supplementary Notes A1 to A3, further including:

an inventory prediction means for predicting a wholesale inventory amount or change of the product for the each unit period in the prediction target period by using the prediction result of the demand for the wholesale shipment and the prediction result of the manufacturer shipment, in which

the display control means displays the prediction result by the inventory prediction means on the display device on the time axis.

### (Supplementary Note A5)

The demand prediction display device according to any one of Supplementary Notes A1 to A4, in which the display control means displays, on the display device on the time axis, at least one of (i) a ratio of the prediction result of the demand of the consumer with respect to the purchase record of the product by the consumer, (ii) a ratio of the prediction result of the demand for the wholesale shipment with respect to the shipment record of the product by the wholesaler, and (iii) a ratio of the prediction result of the demand for the manufacturer shipment with respect to the shipment record of the product by the manufacturer.

### (Supplementary Note A6)

The demand prediction display device according to any one of Supplementary Notes A1 to A5, in which the display control means displays, on the display device, the prediction result by the consumption prediction means, the prediction result by the wholesale shipment prediction means, and the prediction result by the manufacturer shipment prediction means for each classification related to sales of the product.

### (Supplementary Note A7)

The demand prediction display device according to any one of Supplementary Notes A1 to A6, further including:

an acquisition means for acquiring the purchase record data, the wholesale shipment record data, and the manufacturer shipment record data, and

an estimation means for estimating data that could not be acquired by the acquisition means by using the data acquired by the acquisition means when the acquisition means could not acquire some of the purchase record data, the wholesale shipment record data, and the manufacturer shipment record data, in which

the display control means

displays the data acquired by the acquisition means and the data estimated by the estimation means on the display device on the time axis in different display modes.

### (Supplementary Note A8)

The demand prediction display device according to any one of Supplementary Notes A1 to A7, further including:

an accepting means for accepting an input of a correction value by a user with respect to the prediction result of the demand of the consumer, the prediction result of the demand for the wholesale shipment, and the prediction result of the demand for the manufacturer shipment, and

a storage control means for storing, in a storage device, the prediction result of the demand of the consumer, the prediction result of the demand for the wholesale shipment, and the prediction result of the demand for the manufacturer shipment, and the correction value accepted by the accepting means.

### (Supplementary Note A9)

The demand prediction display device according to any one of Supplementary Notes A1 to A8, in which

the display control means

displays the prediction result by the consumption prediction means, the prediction result by the wholesale shipment prediction means, and the prediction result by the manufacturer shipment prediction means on the display device on the time axis in a first display mode, and

displays a purchase record indicated by the purchase record data, shipment record indicated by the wholesale shipment record data, and shipment record indicated by the manufacturer shipment record data on the display device on the time axis in a second display mode.

### (Supplementary Matter B)

The present disclosure includes technologies described in the following Supplementary Notes. However, the present disclosure is not limited to the technologies described in the following Supplementary Notes, and various modifications can be made within the scope described in the claims.

### (Supplementary Note B1)

A demand prediction display method including:

consumption prediction processing in which at least one processor predicts a demand of a consumer for each unit period of a product in a prediction target period by using purchase record data indicating a purchase record of the product by the consumer,

wholesale shipment prediction processing in which the at least one processor predicts a demand for a wholesale shipment for the each unit period of the product in the prediction target period by using wholesale shipment record data indicating a shipment record of the product by a wholesaler,

manufacturer shipment prediction processing in which the at least one processor predicts a demand for a manufacturer shipment for the each unit period in the prediction target period by using manufacturer shipment record data indicating a shipment record of the product by a manufacturer, and

display control processing in which the at least one processor displays a prediction result of the demand of the consumer, a prediction result of the demand for the wholesale shipment, and a prediction result of the demand for the manufacturer shipment for the each unit period in the prediction target period on a display device on a common time axis.

### (Supplementary Note B2)

The demand prediction display method according to Supplementary Note B1, further including:

detection processing in which the at least one processor detects an outlier from the prediction result displayed by the display control processing based on at least one of,

(i) a comparison result between a ratio of the prediction result of the demand of the consumer with respect to the purchase record of the product by the consumer and a ratio of the prediction result of the demand for the wholesale shipment with respect to the shipment record of the product by the wholesaler,

(ii) a comparison result between a ratio of the prediction result of the demand for the wholesale shipment with respect to the shipment record of the product by the wholesaler and a ratio of the prediction result of the demand for the manufacturer shipment with respect to the shipment record of the product by the manufacturer, and

(iii) a comparison result between a ratio of the prediction result of the demand of the consumer with respect to a purchase record of the product by the consumer and a ratio of the prediction result of the demand for the manufacturer shipment with respect to the shipment record of the product by the manufacturer, in which

in the display control processing, the at least one processor displays the detection result by the detection processing on the display device.

### (Supplementary Note B3)

The demand prediction display method according to Supplementary Note B1 or B2, further including:

inventory prediction processing in which the at least one processor predicts retail inventory amount or change of the product for the each unit period in the prediction target period by using the prediction result of the demand of the consumer and the prediction result of the demand for the wholesale shipment, in which

in the display control processing, the at least one processor displays the prediction result by the inventory prediction processing on the display device on the time axis.

### (Supplementary Note B4)

The demand prediction display method according to any one of Supplementary Notes B1 to B3, further including:

inventory prediction processing in which the at least one processor predicts a wholesale inventory amount or change of the product for the each unit period in the prediction target period by using the prediction result of the demand for the wholesale shipment and the prediction result of the manufacturer shipment, in which

in the display control processing, the at least one processor displays the prediction result by the inventory prediction processing on the display device on the time axis.

### (Supplementary Note B5)

The demand prediction display method according to any one of Supplementary Notes B1 to B4, in which in the display control processing, the at least one processor displays, on the display device on the time axis, at least one of (i) a ratio of the prediction result of the demand of the consumer with respect to the purchase record of the product by the consumer, (ii) a ratio of the prediction result of the demand for the wholesale shipment with respect to the shipment record of the product by the wholesaler, and (iii) a ratio of the prediction result of the demand for the manufacturer shipment with respect to the shipment record of the product by the manufacturer.

### (Supplementary Note B6)

The demand prediction display method according to any one of Supplementary Notes B1 to B5, in which in the display control processing, the at least one processor displays, on the display device, the prediction result by the consumption prediction processing, the prediction result by the wholesale shipment prediction processing, and the prediction result by the manufacturer shipment prediction processing for each classification related to sales of the product.

### (Supplementary Note B7)

The demand prediction display method according to any one of Supplementary Notes B1 to B6, further including:

acquisition processing in which the at least one processor acquires the purchase record data, the wholesale shipment record data, and the manufacturer shipment record data, and

estimation processing in which the at least one processor estimates data that could not be acquired in the acquisition processing by using the data acquired by the acquisition processing when some of the purchase record data, the wholesale shipment record data, and the manufacturer shipment record data could not be acquired in the acquisition processing, in which

in the display control processing, the at least one processor

displays the data acquired in the acquisition processing and the data estimated in the estimation processing on the display device on the time axis in different display modes.

### (Supplementary Note B8)

The demand prediction display method according to any one of Supplementary Notes B1 to B7, further including:

acceptance processing in which the at least one processor accepts an input of a correction value by a user with respect to the prediction result of the demand of the consumer, the prediction result of the demand for the wholesale shipment, and the prediction result of the demand for the manufacturer shipment, and

storage control processing in which the at least one processor stores, in a storage device, the prediction result of the demand of the consumer, the prediction result of the demand for the wholesale shipment, and the prediction result of the demand for the manufacturer shipment, and the correction value accepted in the acceptance processing.

### (Supplementary Note B9)

The demand prediction display method according to any one of Supplementary Notes B1 to B8, in which

in the display control processing, the at least one processor

displays the prediction result by the consumption prediction processing, the prediction result by the wholesale shipment prediction processing, and the prediction result by the manufacturer shipment prediction processing on the display device on the time axis in a first display mode, and

displays a purchase record indicated by the purchase record data, shipment record indicated by the wholesale shipment record data, and shipment record indicated by the manufacturer shipment record data on the display device on the time axis in a second display mode.

### (Supplementary Matter C)

The present disclosure includes technologies described in the following Supplementary Notes. However, the present disclosure is not limited to the technologies described in the following Supplementary Notes, and various modifications can be made within the scope described in the claims.

### (Supplementary Note C1)

A demand prediction display program for causing a computer to function as a demand prediction display device, the demand prediction display program causing the computer to function as:

a consumption prediction means for predicting a demand of a consumer for each unit period of a product in a prediction target period by using purchase record data indicating a purchase record of the product by the consumer,

a wholesale shipment prediction means for predicting a demand for a wholesale shipment for the each unit period of the product in the prediction target period by using wholesale shipment record data indicating a shipment record of the product by a wholesaler,

a manufacturer shipment prediction means for predicting a demand for a manufacturer shipment for the each unit period in the prediction target period by using manufacturer shipment record data indicating a shipment record of the product by a manufacturer, and

a display control means for displaying a prediction result of the demand of the consumer, a prediction result of the demand for the wholesale shipment, and a prediction result of the demand for the manufacturer shipment for the each unit period in the prediction target period on a display device on a common time axis.

### (Supplementary Note C2)

The demand prediction display program according to Supplementary Note C1, further causing the computer to function as a detection means for detecting an outlier from the prediction result displayed by the display control means based on at least one of,

(i) a comparison result between a ratio of the prediction result of the demand of the consumer with respect to the purchase record of the product by the consumer and a ratio of the prediction result of the demand for the wholesale shipment with respect to the shipment record of the product by the wholesaler,

(ii) a comparison result between a ratio of the prediction result of the demand for the wholesale shipment with respect to the shipment record of the product by the wholesaler and a ratio of the prediction result of the demand for the manufacturer shipment with respect to the shipment record of the product by the manufacturer, and

(iii) a comparison result between a ratio of the prediction result of the demand of the consumer with respect to a purchase record of the product by the consumer and a ratio of the prediction result of the demand for the manufacturer shipment with respect to the shipment record of the product by the manufacturer, in which

the display control means displays the detection result by the detection means on the display device.

### (Supplementary Note C3)

The demand prediction display program according to Supplementary Note C1 or C2, further causing the computer to function as:

an inventory prediction means for predicting a retail inventory amount or change of the product for the each unit period in the prediction target period by using the prediction result of the demand of the consumer and the prediction result of the demand for the wholesale shipment, in which

the display control means displays the prediction result by the inventory prediction means on the display device on the time axis.

### (Supplementary Note C4)

The demand prediction display program according to any one of Supplementary Notes C1 to C3, further causing the computer to function as:

an inventory prediction means for predicting a wholesale inventory amount or change of the product for the each unit period in the prediction target period by using the prediction result of the demand for the wholesale shipment and the prediction result of the manufacturer shipment, in which

the display control means displays the prediction result by the inventory prediction means on the display device on the time axis.

### (Supplementary Note C5)

The demand prediction display program according to any one of Supplementary Notes C1 to C4, in which the display control means displays, on the display device on the time axis, at least one of (i) a ratio of the prediction result of the demand of the consumer with respect to the purchase record of the product by the consumer, (ii) a ratio of the prediction result of the demand for the wholesale shipment with respect to the shipment record of the product by the wholesaler, and (iii) a ratio of the prediction result of the demand for the manufacturer shipment with respect to the shipment record of the product by the manufacturer.

### (Supplementary Note C6)

The demand prediction display program according to any one of Supplementary Notes C1 to C5, in which the display control means displays, on the display device, a prediction result by the consumption prediction means, a prediction result by the wholesale shipment prediction means, and a prediction result by the manufacturer shipment prediction means for each classification related to sales of the product.

### (Supplementary Note C7)

The demand prediction display program according to any one of Supplementary Notes C1 to C6, further causing the computer to function as:

an acquisition means for acquiring the purchase record data, the wholesale shipment record data, and the manufacturer shipment record data, and

an estimation means for estimating data that could not be acquired by the acquisition means by using the data acquired by the acquisition means when the acquisition means could not acquire some of the purchase record data, the wholesale shipment record data, and the manufacturer shipment record data, in which

the display control means displays the data acquired by the acquisition means and the data estimated by the estimation means on the display device on the time axis in different display modes.

### (Supplementary Note C8)

The demand prediction display program according to any one of Supplementary Notes C1 to C7, further causing the computer to function as:

an accepting means for accepting an input of a correction value by a user with respect to a prediction result of the demand of the consumer, a prediction result of the demand for the wholesale shipment, and a prediction result of the demand for the manufacturer shipment, and

a storage control means for storing, in a storage device, the prediction result of the demand of the consumer, the prediction result of the demand for the wholesale shipment, and the prediction result of the demand for the manufacturer shipment, and the correction value accepted by the accepting means.

### (Supplementary Note C9)

The demand prediction display program according to any one of Supplementary Notes C1 to C8, in which

the display control means

displays a prediction result by the consumption prediction means, a prediction result by the wholesale shipment prediction means, and a prediction result by the manufacturer shipment prediction means on the display device on the time axis in a first display mode, and

displays a purchase record indicated by the purchase record data, shipment record indicated by the wholesale shipment record data, and shipment record indicated by the manufacturer shipment record data on the display device on the time axis in a second display mode.

### (Supplementary Matter D)

The present disclosure includes technologies described in the following Supplementary Notes. However, the present disclosure is not limited to the technologies described in the following Supplementary Notes, and various modifications can be made within the scope described in the claims.

### (Supplementary Note D1)

A demand prediction display device including at least one processor, the at least one processor executing:

consumption prediction processing of predicting a demand of a consumer for each unit period of a product in a prediction target period by using purchase record data indicating a purchase record of the product by the consumer,

wholesale shipment prediction processing of predicting a demand for a wholesale shipment for the each unit period of the product in the prediction target period by using wholesale shipment record data indicating a shipment record of the product by a wholesaler,

manufacturer shipment prediction processing of predicting a demand for a manufacturer shipment for the each unit period in the prediction target period by using manufacturer shipment record data indicating a shipment record of the product by a manufacturer, and

display control processing of displaying a prediction result of the demand of the consumer, a prediction result of the demand for the wholesale shipment, and a prediction result of the demand for the manufacturer shipment for the each unit period in the prediction target period on a display device on a common time axis.

The demand prediction display device may further include a memory. The memory may store a program for causing the at least one processor to execute each of the processing.

### (Supplementary Note D2)

The demand prediction display device according to Supplementary Note D1, in which the at least one processor further executes:

detection processing of detecting an outlier from a prediction result displayed by the display control processing based on at least one of,

(i) a comparison result between a ratio of the prediction result of the demand of the consumer with respect to the purchase record of the product by the consumer and a ratio of the prediction result of the demand for the wholesale shipment with respect to the shipment record of the product by the wholesaler,

(ii) a comparison result between a ratio of the prediction result of the demand for the wholesale shipment with respect to the shipment record of the product by the wholesaler and a ratio of the prediction result of the demand for the manufacturer shipment with respect to the shipment record of the product by the manufacturer, and

(iii) a comparison result between a ratio of the prediction result of the demand of the consumer with respect to a purchase record of the product by the consumer and a ratio of the prediction result of the demand for the manufacturer shipment with respect to the shipment record of the product by the manufacturer, in which

in the display control processing, the at least one processor displays the detection result by the detection processing on the display device.

### (Supplementary Note D3)

The demand prediction display device according to Supplementary Note D1 or D2, in which

the at least one processor further executes:

inventory prediction processing of predicting a retail inventory amount or change of the product for the each unit period in the prediction target period by using the prediction result of the demand of the consumer and the prediction result of the demand for the wholesale shipment, in which

in the display control processing, the at least one processor displays the prediction result by the inventory prediction processing on the display device on the time axis.

### (Supplementary Note D4)

The demand prediction display device according to any one of Supplementary Notes D1 to D3, in which

the at least one processor further executes:

inventory prediction processing of predicting a wholesale inventory amount or change of the product for the each unit period in the prediction target period by using the prediction result of the demand for the wholesale shipment and the prediction result of the manufacturer shipment, in which

in the display control processing, the at least one processor displays the prediction result by the inventory prediction processing on the display device on the time axis.

### (Supplementary Note D5)

The demand prediction display device according to any one of Supplementary Notes D1 to D4, in which in the display control processing, the at least one processor displays, on the display device on the time axis, at least one of (i) a ratio of the prediction result of the demand of the consumer with respect to the purchase record of the product by the consumer, (ii) a ratio of the prediction result of the demand for the wholesale shipment with respect to the shipment record of the product by the wholesaler, and (iii) a ratio of the prediction result of the demand for the manufacturer shipment with respect to the shipment record of the product by the manufacturer.

### (Supplementary Note D6)

The demand prediction display device according to any one of Supplementary Notes D1 to D5, in which in the display control processing, the at least one processor displays, on the display device, a prediction result by the consumption prediction processing, a prediction result by the wholesale shipment prediction processing, and a prediction result by the manufacturer shipment prediction processing for each classification related to sales of the product.

### (Supplementary Note D7)

The demand prediction display device according to any one of Supplementary Notes D1 to D6, in which

the at least one processor further executes:

acquisition processing of acquiring the purchase record data, the wholesale shipment record data, and the manufacturer shipment record data, and

estimation processing of estimating data that could not be acquired in the acquisition processing by using the data acquired by the acquisition processing when some of the purchase record data, the wholesale shipment record data, and the manufacturer shipment record data could not be acquired in the acquisition processing, in which

in the display control processing, the at least one processor

displays the data acquired in the acquisition processing and the data estimated in the estimation processing on the display device on the time axis in different display modes.

### (Supplementary Note D8)

The demand prediction display device according to any one of Supplementary Notes D1 to D7, in which

the at least one processor further executes:

acceptance processing of accepting an input of a correction value by a user with respect to a prediction result of the demand of the consumer, a prediction result of the demand for the wholesale shipment, and a prediction result of the demand for the manufacturer shipment, and

storage control processing of storing, in a storage device, the prediction result of the demand of the consumer, the prediction result of the demand for the wholesale shipment, and the prediction result of the demand for the manufacturer shipment, and the correction value accepted in the acceptance processing.

### (Supplementary Note D9)

The demand prediction display device according to any one of Supplementary Notes D1 to D8, in which

in the display control processing, the at least one processor

displays a prediction result by the consumption prediction processing, a prediction result by the wholesale shipment prediction processing, and a prediction result by the manufacturer shipment prediction processing on the display device on the time axis in a first display mode, and

displays a purchase record indicated by the purchase record data, shipment record indicated by the wholesale shipment record data, and shipment record indicated by the manufacturer shipment record data on the display device on the time axis in a second display mode.

### (Supplementary Matter E)

The present disclosure includes technologies described in the following Supplementary Note. However, the present disclosure is not limited to the technologies described in the following Supplementary Note, and various modifications can be made within the scope described in the claims.

### (Supplementary Note E1)

A non-transitory recording medium recorded with a demand prediction display program for causing a computer to function as a demand prediction display device, the demand prediction display program causing the computer to execute;

consumption prediction processing of predicting a demand of a consumer for each unit period of a product in a prediction target period by using purchase record data indicating a purchase record of the product by the consumer,

wholesale shipment prediction processing of predicting a demand for a wholesale shipment for the each unit period of the product in the prediction target period by using wholesale shipment record data indicating a shipment record of the product by a wholesaler,

manufacturer shipment prediction processing of predicting a demand for a manufacturer shipment for the each unit period in the prediction target period by using manufacturer shipment record data indicating a shipment record of the product by a manufacturer, and

display control processing of displaying a prediction result of the demand of the consumer, a prediction result of the demand for the wholesale shipment, and a prediction result of the demand for the manufacturer shipment for the each unit period in the prediction target period on a display device on a common time axis.

1. A demand prediction display device comprising:
a memory configured to store instructions; and
one or more processors configured to execute the instructions to:
predict a demand of a consumer for each unit period of a product in a prediction target period by using purchase record data indicating a purchase record of the product by the consumer;
predict a demand for a wholesale shipment for the each unit period of the product in the prediction target period by using wholesale shipment record data indicating a shipment record of the product by a wholesaler;
predict a demand for a manufacturer shipment for the each unit period in the prediction target period by using manufacturer shipment record data indicating a shipment record of the product by a manufacturer; and
display a prediction result of the demand of the consumer, a prediction result of the demand for the wholesale shipment, and a prediction result of the demand for the manufacturer shipment for the each unit period in the prediction target period on a display device on a common time axis.

2. The demand prediction display device according to claim 1, wherein
the one or more processors are further configured to execute the instructions to:
detect an outlier from the prediction result based on at least one of,
(i) a comparison result between a ratio of the prediction result of the demand of the consumer with respect to the purchase record of the product by the consumer and a ratio of the prediction result of the demand for the wholesale shipment with respect to the shipment record of the product by the wholesaler,
(ii) a comparison result between a ratio of the prediction result of the demand for the wholesale shipment with respect to the shipment record of the product by the wholesaler and a ratio of the prediction result of the demand for the manufacturer shipment with respect to the shipment record of the product by the manufacturer, and
(iii) a comparison result between a ratio of the prediction result of the demand of the consumer with respect to a purchase record of the product by the consumer and a ratio of the prediction result of the demand for the manufacturer shipment with respect to the shipment record of the product by the manufacturer; and
display a prediction result of the outlier on the display device.

3. The demand prediction display device according to claim 1, wherein
the one or more processors are further configured to execute the instructions to:
predict a retail inventory amount or change of the product for the each unit period in the prediction target period by using the prediction result of the demand of the consumer and the prediction result of the demand for the wholesale shipment; and
display a prediction result of the retail inventory amount or the change of the product on the display device on the time axis.

4. The demand prediction display device according to claim 1, wherein
the one or more processors are further configured to execute the instructions to:
predict a wholesale inventory amount or change of the product for the each unit period in the prediction target period by using the prediction result of the demand of the wholesale shipment and the prediction result of the manufacturer shipment; and
display a prediction result of the wholesale inventory amount or the change of the product on the display device on the time axis.

5. The demand prediction display device according to claim 1, wherein
the one or more processors are further configured to execute the instructions to:
display, on the display device on the time axis, at least one of (i) a ratio of the prediction result of the demand of the consumer with respect to the purchase record of the product by the consumer, (ii) a ratio of the prediction result of the demand for the wholesale shipment with respect to the shipment record of the product by the wholesaler, and (iii) a ratio of the prediction result of the demand for the manufacturer shipment with respect to the shipment record of the product by the manufacturer.

6. The demand prediction display device according to claim 1, wherein
the one or more processors are further configured to execute the instructions to:
display, on the display device, the prediction result of the demand of the consumer for the each unit period of the product in the prediction target period, the prediction result of the demand for the wholesale shipment for the each unit period of the product in the prediction target period, and the prediction result of the demand for the manufacturer shipment for the each unit period in the prediction target period for each classification related to sales of the product.

7. The demand prediction display device according to claim 1, wherein
the one or more processors are further configured to execute the instructions to:
acquire the purchase record data, the wholesale shipment record data, and the manufacturer shipment record data;
in a case where some of the purchase record data, the wholesale shipment record data, and the manufacturer shipment record data are not acquired, estimate data that is not acquired using the acquired data; and
display the acquired data and the estimated data on the display device on the time axis in different display modes.

8. The demand prediction display device according to claim 1, wherein
the one or more processors are further configured to execute the instructions to:
accept an input of a correction value by a user with respect to the prediction result of the demand of the consumer, the prediction result of the demand for the wholesale shipment, and the prediction result of the demand for the manufacturer shipment; and
store, in a storage device, the prediction result of the demand of the consumer, the prediction result of the demand for the wholesale shipment, the prediction result of the demand for the manufacturer shipment, and the accepted correction value.

9. The demand prediction display device according to claim 4, wherein
the one or more processors are further configured to execute the instructions to:
receive a correction value for at least one of the prediction results, the correction value being inputted by a user based on the displayed prediction results; and
control the display device to display the correction value alongside the original prediction result, thereby supporting the user's final decision making process for demand planning.

10. The demand prediction display device according to claim 6, wherein
the predicting the retail inventory amount or the change includes calculating the retail inventory amount or the change based on the prediction result of the wholesale shipment demand and the prediction result of the consumer demand, and
the prediction result of the consumer demand is obtained from a trained model generated by machine learning.

11. A demand prediction display method comprising:
predicting a demand of a consumer for each unit period of a product in a prediction target period by using purchase record data indicating a purchase record of the product by the consumer;
predicting a demand for a wholesale shipment for the each unit period of the product in the prediction target period by using wholesale shipment record data indicating a shipment record of the product by a wholesaler;
predicting a demand for a manufacturer shipment for the each unit period in the prediction target period by using manufacturer shipment record data indicating a shipment record of the product by a manufacturer; and
displaying a prediction result of the demand of the consumer, a prediction result of the demand for the wholesale shipment, and a prediction result of the demand for the manufacturer shipment for the each unit period in the prediction target period on a display device on a common time axis.

12. A non-transitory computer-readable recording medium storing a demand prediction display program for causing a computer to execute the steps of:
predicting a demand of a consumer for each unit period of a product in a prediction target period by using purchase record data indicating a purchase record of the product by the consumer;
predicting a demand for a wholesale shipment for the each unit period of the product in the prediction target period by using wholesale shipment record data indicating a shipment record of the product by a wholesaler;
predicting a demand for a manufacturer shipment for the each unit period in the prediction target period by using manufacturer shipment record data indicating a shipment record of the product by a manufacturer; and
displaying a prediction result of the demand of the consumer, a prediction result of the demand for the wholesale shipment, and a prediction result of the demand for the manufacturer shipment for the each unit period in the prediction target period on a display device on a common time axis.
